(19) United States
(12) Patent Application Publication
(10) Pub. No.: US 2011/0316317 A1
(43) Pub. Date: Dec. 29, 2011

(54) ADJUSTABLE VEHICLE SEAT

(75) Inventors: Erik Sprenger, Wermelskirchen (DE); Stefan Heuel, Herdorf (DE); Salih Yilmaz, Koln (DE); Jorg Seibt, Bruehl (DE)

(73) Assignee: Johnson Controls GmbH, Burscheid (DE)

(21) Appl. No.: 12/160,962

(22) PCT Filed: Jan. 19, 2007
(86) PCT No.: PCT/EP2007/000462

§ 371 Date: Dec. 2, 2010

(30) Foreign Application Priority Data
Jan. 19, 2006 (DE) 10 2006 002 823.6

(51) Int. Cl. B60N 2/30; B60N 2/20

(52) U.S. Cl. 297/344.1

(57) ABSTRACT

An adjustable seat for a vehicle includes a seat part having a first seat position and a second seat position relative to a floor of the vehicle. The seat also includes a quick unlocking device that unlocks the adjusting device to adjust the seat. An adjusting device moves the seat part between the first seat position and the second position. The vehicle seat also includes a backrest part pivotably connected to the seat part. The backrest part is operatively connected to the quick unlocking adjusting device such that pivoting of the backrest part between an upright position and a folded over position unlocks the adjusting device.

### CROSS REFERENCE TO RELATED APPLICATIONS

The present application is National Stage filing of International Application No. PCT/EP2007/000462, filed on Jan. 19, 2007, titled “Vehicle Seat Comprising a Height-Adjustable Region and a Lowered Position” which claims priority to German Patent Application No. DE 10 2006 002 823.6, filed Jan. 19, 2006, the entire disclosures of which are incorporated herein by reference.

### BACKGROUND

The present disclosure relates to a vehicle seat, and more specifically to an adjusting device for adjusting the position of the seat.

Vehicle seats may be adjustable to ensure comfort for the user. In addition, vehicle seats may be adjustable to provide additional functions, such as a surface for loading or as a table function, or the like. An example of an adjustable vehicle seat is described in German published patent application DE 101 49 858 A1, in which the backrest may be folded forward and at the same time the seat part lowered to form a unit of compact size. While this system works, it is difficult for the user to both adjust the height of the vehicle seat and, in an easy and simple manner, vary a height of the seat part in a user-friendly manner.

Thus, there is a need in the art for an adjustable vehicle seat that is multi-functional and operational in an ergonomic and intuitive manner using a quick adjustment device.

### SUMMARY

Accordingly, the present disclosure relates to an adjustable seat for a vehicle. The seat includes a seat part having a first seat position and a second seat position relative to a floor of the vehicle. The seat also includes a quick unlocking device that unlocks the adjusting device to adjust the seat. An adjusting device moves the seat part between the first seat position and the second position. The vehicle seat also includes a backrest part pivotably connected to the seat part. The backrest part is operatively connected to the quick unlocking adjusting device such that pivoting of the backrest part between an upright position and a folded over position unlocks the adjusting device.

Other features and advantages of the present disclosure will be readily appreciated, as the same becomes better understood in view of the subsequent description taken in conjunction with the accompanying drawings.

### BRIEF DESCRIPTION OF THE DRAWINGS

FIG. 1 is an inner side view of a vehicle seat in a first seat position within a seat part adjustment range.

FIG. 2 is an inner side view of a vehicle seat in a first seat position within a seat part adjustment range.

FIG. 3 is an inner side view of a vehicle seat in a first seat position within a seat part adjustment range

FIG. 4 is an outer side view of the vehicle seat in a first seat position within a seat part adjustment range.

FIG. 5 is an outer side view of the vehicle seat in a first seat position within a seat part adjustment range.

FIG. 6 is an outer side view of the vehicle seat in a second seat position.

FIG. 7 is an inner side view of the vehicle seat in the first seat position of the seat part corresponding to FIG. 4.

FIG. 8 is an inner side view of the vehicle seat in the first seat position of the seat part corresponding to FIG. 5.

FIG. 9 is an inner side view of the vehicle seat in the second seat position of the seat part corresponding to FIG. 6.

FIG. 10 is a perspective view of the quick unlocking device for the vehicle seat.

FIG. 11 is a perspective view of a second example of the quick unlocking device.

FIG. 12 is an enlarged view of the quick unlocking device of FIG. 11.

### DESCRIPTION

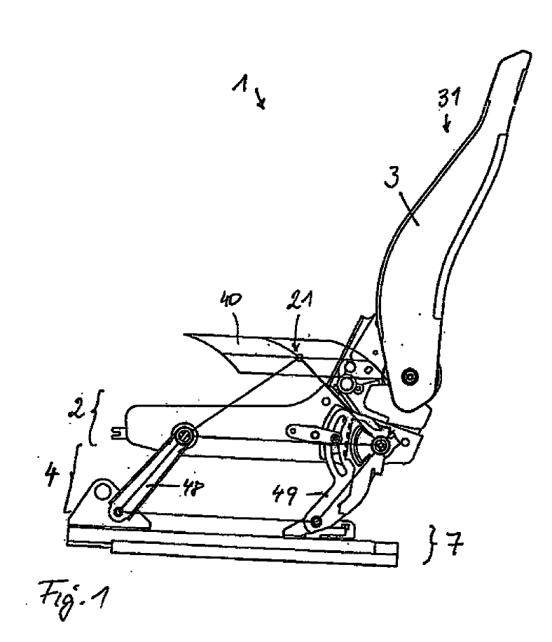

FIGS. 1 to 12 are described together hereinafter. A vehicle seat 1 includes a seat part 2 and a backrest part 3. The seat 2 has an adjusting device 4 by which a relative position of the seat part 2 may be varied. For example, the height or the inclination or the like of the seat part 2 may be altered by a user. The vehicle seat 1, in addition to the seat part 2, also includes a backrest part 3 that is pivotable with respect to the seat part 2. The backrest part 3 may also be adjustable. For example, a height or inclination of the backrest part 3 may be varied by the adjusting device 4. The adjusting device 4 modifies the relative position of the seat part 2 within a predetermined seat part adjustment range 40. For example, the adjustment range may include different height and/or inclination positions.

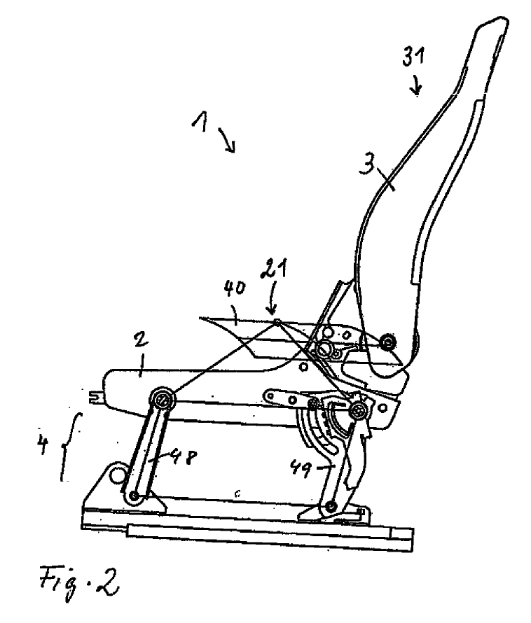

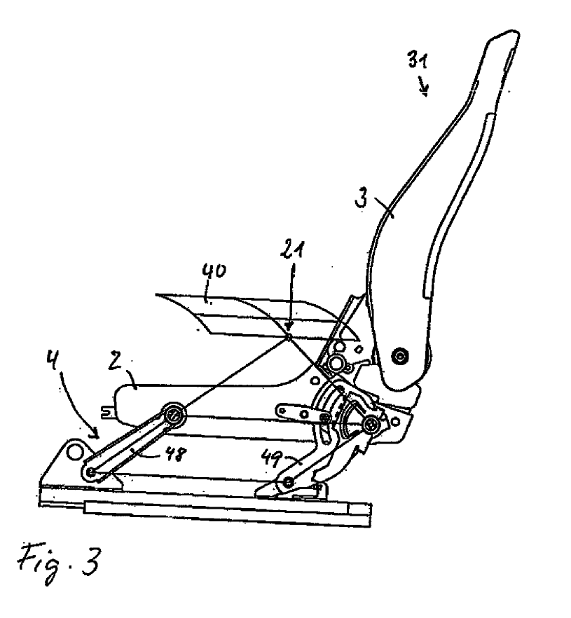

Referring to FIGS. 1 to 3, examples of the vehicle seat within the seat part adjustment range 40 are shown. A first seat position of the seat part 2 as shown at 21 is within the seat part adjustment range 40. In FIG. 1, for example, the seat part 2 is shown set at a middle position within the seat part adjustment range 40, while the seat part 2 in FIG. 2 is shown set at its highest and in FIG. 3 shown at its lowest setting.

The adjustment device 4 includes an arrangement of guide rods, such as a front guide rod 48 and a rear guide rod 49. The guide rods 48, 49 are pivotably connected to a seat support structure 7 and pivotally adjust the vehicle seat. For example, height or inclination of the seat part 2 may be varied by pivotal movement of the guide rods. The front and rear guide rods 48, 49 respectively may be arranged in pairs to the side of the seat 1, although other arrangements are contemplated. Referring to FIGS. 1 to 3, an inside view of the seat 1 as illustrated, i.e. from the middle of the seat.

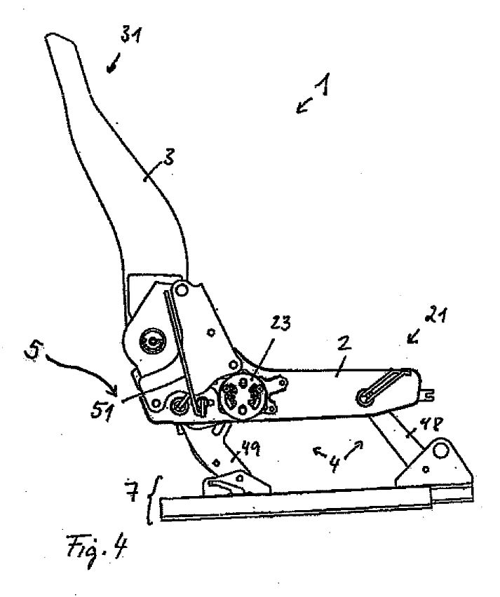

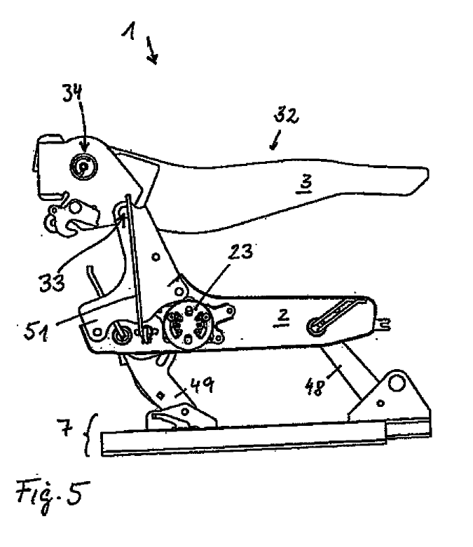

Referring to FIGS. 4 to 6, an outside view of the seat 1 is illustrated. In FIG. 4, the seat part 2 is set in a first seat position 21, within the seat part adjustment range 40. The backrest part 3 of the seat 1 is in a typical position 31 for a seated occupant, which is generally upright or perpendicular to a relative position of the seat surface of the seat part 2. This position of the backrest part 3 corresponds to a seated position by a user. In FIG. 5, a folded over position 32 of the backrest part 3 is shown, in which the backrest part 3 is rotated and/or pivoted relative to the normal seated position 31 (FIG. 4) by approximately 90° to approximately 120°. The seat part 2 and the backrest part 3 are interconnected at pivot axis 33, about which the backrest part 3 may pivot to reach the folded over position 32. The backrest part 3 may also include a second backrest adjusting device 34 for obtaining a relatively fine position of the backrest inclination within the range of the upright position 31 of the backrest. Moreover, the second backrest adjusting device 34 may also provide an additional folding or pivoting feature of the backrest 3, such as to the rear. It should be appreciated that one pivot axis, such as the pivot axis 33, may provide for the pivoting of the backrest 3 from the upright position 31 into the folded over position 32 and for the fine adjustment of the inclination of the backrest part 3. In another example, these two pivot axes do not coincide. In this example, pivoting of the backrest part 3 between the upright position 31 and the folded over position 32 correspond to the pivot axis 33.

Referring to FIGS. 4, 5 and 6, an actuating device 23 may be located on the seat part 2 for actuating the adjusting device 4. For example, the actuating device 23 may be operated manually, such as by using a repetitive motion, to set the seat height by actuating the adjusting device 4 within the seat part adjusting range 40. In another example, the actuating device 23 and the adjusting device 4 may be mechanically, pneumatically or hydraulically actuated using a motor, such as an electric motor or the like.

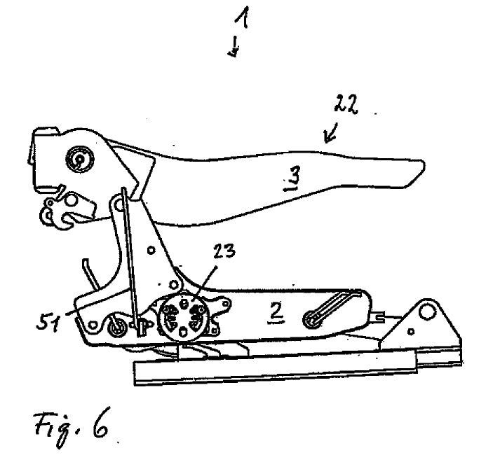

Referring to FIG. 6, the seat part 2 is located at a second seat position 22. The second seat position 22 may be at a limit of the seating part adjusting range 40 or outside the seating part adjusting range 40. The seat may be moved from a first seat position 21 within the seat part adjusting range 40 to the second seat position 22 by the actuation of a quick unlocking device 5. The quick unlocking device 5 unlocks the adjusting device 4. Actuation of the quick unlocking device 5 and the actuation of the unlocking of the adjusting device 4 may occur due to movement of the backrest part 3 to an upright position while the seat 1 is in a second seat position. In another example, a control member 51 may be connected to the backrest part 3 such that the movement of the backrest part 3 from an upright position 31 to a folded over position 32 causes an actuation of the quick unlocking device 5 and thus an unlocking of the first adjusting device 4.

Accordingly, the second seat position 22 of the seat part 2, as shown in FIG. 6, may be a lowered or raised position relative to that of the first seat position within the seat part adjustment 40. For example, the guide rods 48, 49 of the adjusting device 4 may be configured to be longer to spatially extend the movement of the seat part within the limits of the seat part adjustment 40. To achieve the second seat position 22, the seat part 2 may be folded fully downwards to lower the seat. In this position, a rear face of the backrest part 3 may be used as an extension of a motor vehicle loading surface. In another example, a rear face of the backrest 3 may be used as a table or the like. In still another example, the folded over position 32 of the backrest part 3 is to the rear, i.e. away from the seat part 2. It should be appreciated that the second seat position 22 may be raised relative to the setting range 40. In addition, two second seat positions 22, such as a very low second seat position and a raised second seat position 22 may be provided.

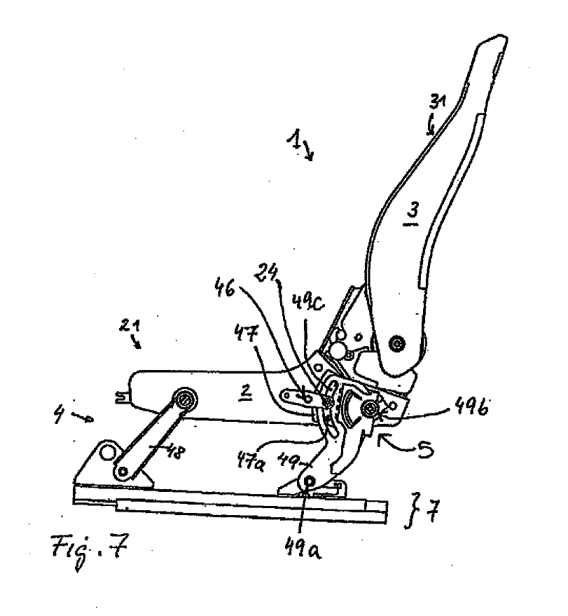

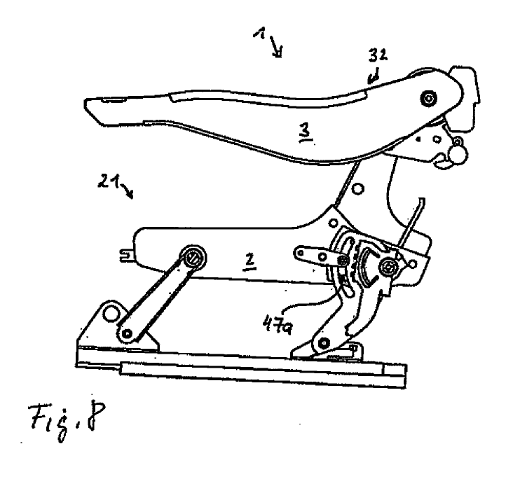

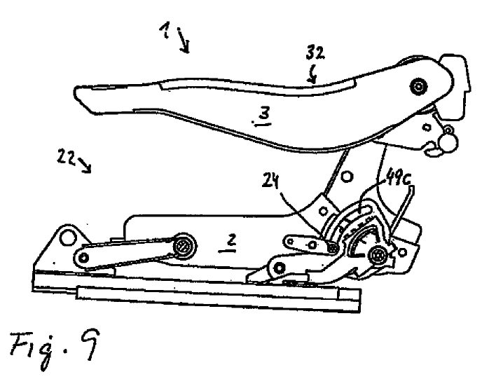

Referring to FIGS. 7 to 9, side views of the seat part are illustrated from the inner face of the seat. The position of the seat in FIG. 7 corresponds to that of FIG. 4. The position of the seat in FIG. 8 corresponds to that of FIG. 5 and the position of the seat in FIG. 9 corresponds to that of FIG. 6.

The rear guide rod 49, may be rotatably or pivotably connected to a seat supporting structure 7 at a first pivot point 49a. The opposed end of the guide rod 49 is rotatably connected to the seat part 2 at the second pivot point 49b. The inclination or the height of the seat part 2 may be adjusted by rotating the guide rod 49. It should be appreciated that the front guide rod 49 may or may not rotate concurrently, depending on the desired adjustment.

The guide rod 49 includes a first slot 49c, and a first pin 24 connected fixedly to the seat part 2 extends through the slot 49c. Adjustment of the seat part 2, such as the height or inclination, is controlled by the travel of the first pin 24 within the first slot 49c of the guide rod. Locating the first pin 24 at the lower end of the slot 49c corresponds to the second seat position 22 of the seat 1 as shown in FIG. 9. Positioning the first pin 24 within the upper region of the first slot 49c corresponds to positioning the seat 1 with the seating part adjustment range 40 of the first seat position 21, as shown in FIGS. 7 and 8.

The guide rod 49 includes a toothed segment 47 which is rotatable about the second pivot point 49b. The toothed segment may be secured to the seat part 2 at the second pivot point 49b. The toothed segment meshes with a toothed wheel when adjusting the height of the seat part 2 within the setting range 40. The toothed wheel is fixedly and rotatable connected to the seat part 2 at a third pivot point 46, as shown in FIGS. 7 to 9. The toothed segment 47 may include a second slot 47a that defines limits of the setting range 40. For example, the pin 24 may be located at one end of the second slot 47a or one setting of the seat within the seat part adjustment range 40, and at the other end of the slot 47a the opposed setting of the seat part adjustment range 40. The toothed wheel is mounted on the third pivot point 46 and driven by the actuating device 23 to mesh with the external teeth of the toothed segment 47 to adjust the seat part 2 over the seat part adjustment range 40. A synchronous movement of the guide rod 49 and of the toothed segment 47 takes place, as shown in FIGS. 1 to 3.

The adjusting device 4, includes the actuating device 23, the toothed wheel mounted at the third pivot point 46, the toothed segment 47 and the guide rod 49. The first pin 24 may extend through both the first slot 49c of the guide rod 49 and through the second slot 47a of the toothed segment 47. The toothed segment 47 and the guide rod 49 move together when adjusting the seat height or inclination of the seat part 2 within the seat part adjustment range 40, using the adjusting device 4.

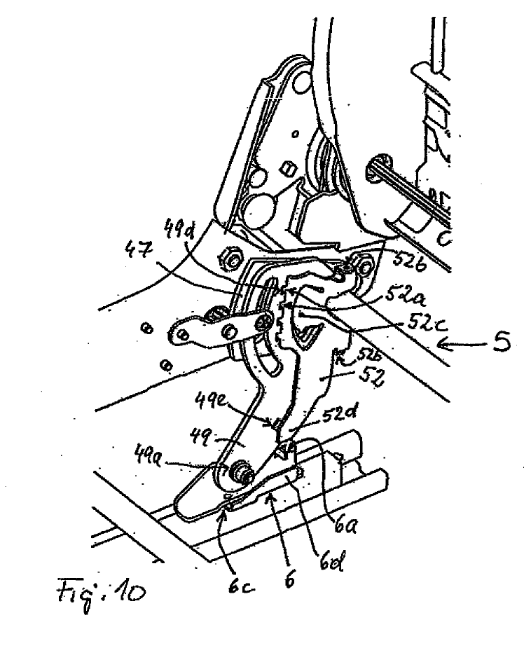

The combined of movement of the toothed segment 47 and the guide rod 49 occurs, since the adjusting device 4 is unlocked. The quick unlocking device 5 includes the control member 51, and an unlocking member 52. The unlocking member 52 includes protrusions 52a, such as teeth or pins or the like. The teeth 52a are engagable both in the corresponding first recesses 49d of the guide rod 49 and also in second recesses of the toothed segment 47. The locked position of the adjusting device 4 is shown in FIG. 10. The unlocking member 52 may be set in a locked position as shown in FIG. 10. In the locked position, the guide rod 49 and the toothed segment 47 the locked together by engagement of the teeth 52a or pin 52a within the first recesses 49d of the guide rod. As a result, the movement of the guide rod 49 and of the toothed segment 47 occurs in unison over the seat part adjustment range 40.

The control member 51 may facilitate movement of the unlocking member 52 about a fourth pivot point 52b using a pivot pin, which extends substantially parallel to the guide rod 49. The unlocking member 52 may pivot in a direction relative to the middle of the seat, such that the comb-like locking teeth 52a are brought out of engagement relative to the toothed segment 47. As a result, the toothed segment 47 and the guide rod 49 are unlocked. The seat part 2 may be positioned, and the first pin 24 may move within the entire range of the first slot 49c, and not be restricted to the range of the second slot 47a. The position of the toothed segment 47 relative to the first pin 24 is maintained after disengaging the unlocking member 52. The first pin 24 moves in the first slot 49c as the seat part 2 is adjusted.

The movement of the unlocking member 52 about the fourth pivot point 52b in an unlocking direction is controlled by an actuating mechanism with the assistance of the control member 51. An example of a control member 51 is an actuating pin extending substantially parallel to the pin 24 or to the first pivot point 49a. The actuating pin acts on a contact portion 52c of the unlocking member 52 and causes the rotation of the unlocking member 52 about the fourth pivot point 52b. The actuating pin may be located on the outside of the seat towards a rear face of the actuating region 52c. Both the toothed segment 47 and the guide rod 49 may have a recess in this area. In this example, the actuating region 52c is bent inwardly towards the toothed segment 47. The actuating region 52a cooperates with the recess in the toothed segment 47 when rotated about the second pivot point 49b. The spring-loaded unlocking member 52 is supported on the edge of the corresponding recess in the toothed segment 47, such that the unlocking member 52, including the locking teeth 52a, does not engage the toothed segment 47.

In operation, the backrest part 3, is folded forward within the first seat position by moving the control member 51 and the actuating pin to rotate the unlocking member 52 about the fourth pivot point 52b, to unlock the toothed segment 47 from the guide rod 49. In addition, the position of the backrest part 3 may be varied within the first seat position, since the actuating region 52c is supported on the toothed segment 47 in its locked position. Irrespective of the position of the backrest part 3, the seat part may also be varied in the first seat position. In addition, the seat 1 may be positioned in the second seat position 22. The quick unlocking device is actuated by raising the backrest to an upright position from a folded over position. The unlocking member 52 may reengage the toothed segment 47, and the guide rod 49 returned to its previous position, so that the previously set first seat position of the seat part 2 is reached. Locking of the unlocking member 52 takes place when the backrest part 3 is returned to the upright position 31.

It should be appreciated that the quick unlocking device 5 may be actuated in various ways. For example, the quick unlocking device 5 may be actuated using a separate actuating device, or by a movement of the backrest. Actuation of the quick unlocking device or movement of the backrest 3 is intuitive for a user.

In yet another example, a position of the seat part 2 may be locked when the seat part 2 is set in the second seat position 22. For example, if the second seat position 22 is adjacent to the floor 7a of the vehicle, i.e. completely lowered, locking is possible in the area of the first pivot point 49a of the guide rod 49. As shown, in FIG. 10, a lower part 52d of the unlocking member 52 may cooperate with a locking device 6 positioned near the first pivot point 49a of the guide rod 49. For example, the locking device 6 includes a lug 6a having on its upper face an oblique contact surface, and which may engage in a second recess 49e of the guide rod 49. The locking device 6 may be rotated about a fifth pivot point 6c and may be spring-loaded, so that the locking lug 6a may engage in the second recess 49e. An unlocking tab 6d on the locking mechanism 6 may be able to cooperate with the lower end 52d of the unlocking member 52, such that the locking mechanism 6 is set counter to its spring tensioning in its unlocked position and thus releases the guide rod 49. The movement of the unlocking member 52 corresponds to a movement of the backrest 3 from the folded over position 32 to the seated position 31.

In operation, unlocking the toothed segment 47 from the guide rod 49 takes place during a first partial range of movement of the unlocking member 52 and a movement of the backrest part 3 from the upright position 31 to the folded over position 32, such as over approximately half of the path between the two positions. With a further pivoting of the backrest 3 towards the folded over position 32, the unlocking member 52 is rotated further about the fourth pivot point 52b and thus over a second portion of the unlocking movement range. To unlock the locking mechanism 6, the second portion of the unlocking movement is again reversed. For example, the backrest 3 moves from its folded over position 32 over half of the path towards the upright position 31.

After unlocking the adjusting device 4 to adjust the seat part 2, the seat may include an energy storage mechanism such as a spring so that the seat part 2 does not sink down due to a force of its own weight. For example, the weight of the seat part 2 may be compensated for using springs, such that the user exerts a slight downward pressure onto the seat part 2 in the second seat position, until the locking is effected by the locking mechanism 6. After unlocking the locking mechanism 6, this spring force returns the seat part 2 upward again.

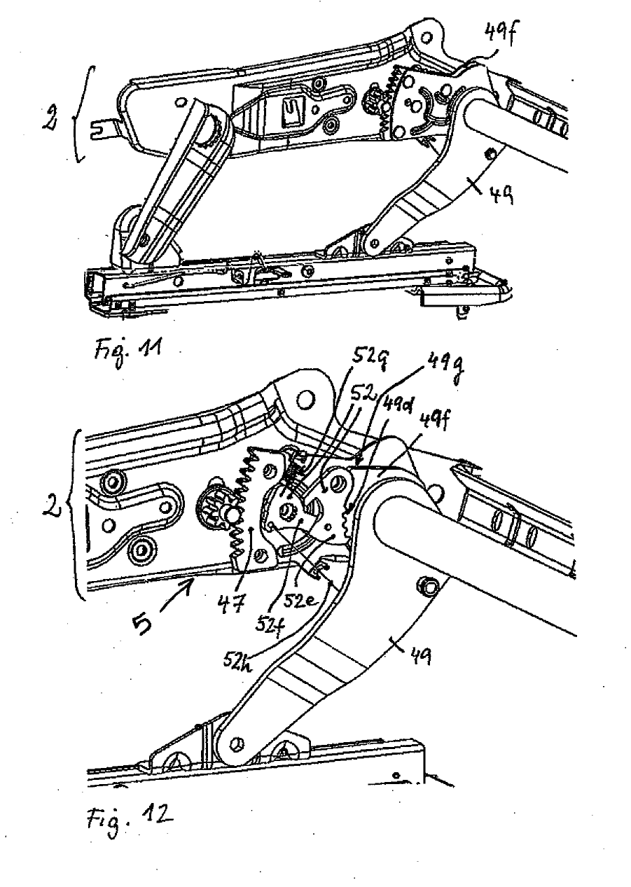

Referring to FIGS. 11 and 12 a further example of the quick unlocking device 5 is illustrated. In this example the quick unlocking device coordinates movement between the toothed segment 47 and the guide rod 49.

The guide rod 49 includes a planer counter element 49f, having a recess 49d or a toothed portion 49d or the like, that cooperates with the unlocking member 52 in a closed condition of the quick unlocking device, as shown in FIG. 2. The quick unlocking device 5 includes, a pawl 52e and a cam 52f rotatably connected to a fixed pivot pin, so that the unlocking member 52 moves substantially together with the seat part 2. To actuate the quick unlocking device 5, a spring 52g pulls the cam 52f into the closed position of the quick unlocking device 52. An actuator, such as a Bowden cable 52h or the like positions the cam 52f into a deflected or unlocked position, such as by folding the backrest 3 in forward direction. As a result, the pawl 52e is released from the toothed portion 49d and/or the first recesses 49d of the guide rod 49 or of the counter element 49f and the quick unlocking device 5 is actuated. The position of the adjusting device 4 remains the same i.e. the previously set position or adjusted position, so that the quick unlocking device 5 can be actuated and the second seat position 22 of the seat part 2 may be adopted. As a result, the unlocked setting of the quick unlocking device 5 or the unlocking member 52 is unchanged. In this position a stop may be disposed between the unlocking member 52 such as by using the pawl 52e, or a stop 49g, or a stop lug 49g of the guide rod 49, or the counter element 59f or the like. Advantageously the quick unlocking device 5 and, the unlocking member 52 may be moved together with the seat part 2. As a result, the actuating means 52h may be controlled in a simple manner with the backrest 3.

The present disclosure has been described as an illustrative manner. It is to be understood that the terminology which has been used is intended to be in the nature of words of description rather than of limitation.

Many modifications and variations of the present disclosure are possible in light of the above teachings. Therefore, the present disclosure may be practiced other than as specifically described.

What is claimed is:

1. An adjustable seat for a vehicle comprising:
a seat part having a first seat position and a second seat position relative to a floor of the vehicle;
a backrest pivotally connected to the seat part;
an adjusting device for moving the seat part between the first seat position and the second seat position; and
a unlocking device operatively connected to the backrest for unlocking the adjusting device by pivoting the backrest between an upright position and a folded over position.

2. The vehicle seat as set forth in claim 1 wherein pivoting of the backrest part from the upright position to the folded over position while in the first seat position actuates the adjusting device to unlock the adjusting device.

3. The vehicle seat as set forth in claim 1 further comprising a locking mechanism for locking the seat part in the second seat position.

4. The vehicle seat as set forth in claim 3 wherein of the backrest part from the folded over position in the second seat position to the upright position in the first seat position unlocks the locking mechanism.

5. The vehicle seat as set forth in claim 2 wherein the backrest part pivots between 90° to 120° from the upright position to the folded over position, and the backrest part is substantially horizontal to the seat part in the folded over position.

6. The vehicle seat as set forth in claim 1 wherein the adjusting device returns to a locked position after the seat part returns to the first seat position from the second seat position.

7. The vehicle seat as set forth in claim 1, wherein the adjusting device adjusts the seat within a predetermined adjustment range in the first seat position, and second seat position is outside the predetermined adjustment range for the first seat position.

8. The vehicle seat as set forth in claim 1, wherein the second seat position is a lowered seat part position with respect to the floor of the vehicle.

9. The vehicle seat as set forth in claim 1, wherein the unlocking device has an unlocking member, and the unlocking member moves substantially together with the adjusting device.

10. The vehicle seat set forth in claim 1 wherein the unlocking device has an unlocking member and, the unlocking member moves substantially together with the seat part.

11. The vehicle seat as set forth in claim 1 wherein the quick unlocking device includes:
a control member connected to the backrest part that is actuated by moving the backrest part between the upright position and the folded over position; and
an unlocking member having one end pivotally attached to the seat at a fourth pivot point, wherein the unlocking member engages the adjusting device in a locked position, and actuation of the control member pivots the unlocking member about the fourth pivot point to disengage the unlocking member from the adjusting device and unlock the adjusting device.

12. An adjustable seat for a vehicle comprising:
a seat part having a first seat position and a second seat position relative to a floor of the vehicle;
a backrest pivotally connected to the seat part;
an adjusting device for moving the seat part between the first seat position and the second seat position; and
a quick unlocking device operatively connected to the backrest for unlocking the adjusting device, wherein pivoting of the backrest part from the upright position to the folded over position while in the first seat position actuates the quick adjusting device to unlock the adjusting device to move the seat to the second seat position and pivoting the backrest part from the folded over position in the second seat position to the upright position unlocks the adjustment device to move the seat to the first seat position.

13. The vehicle seat as set forth in claim 12 wherein the second seat position is outside the predetermined adjustment range of the first position.

14. The vehicle seat as set forth in claim 12 wherein the quick unlocking device includes:
a control member connected to the backrest part that is actuated by moving the backrest part between the upright position and the folded over position;
an unlocking member having one end pivotally attached to the seat at a fourth pivot point, wherein the unlocking member engages the adjusting device in a locked position, and actuation of the control member pivots the unlocking member about the fourth pivot point to disengage the unlocking member from the adjusting device and unlock the adjusting device.

15. The vehicle seat as set forth in claim 12 wherein the adjusting device includes:
a guide rod having one end attached to the seat part, wherein the guide rod includes an elongated slot having a predetermined length for controlling the adjustment of the seat part within a predetermined adjustment range for the first seat position;
a toothed segment adjacent the guide rod, wherein the toothed segment includes an elongated slot having a predetermined length that is less than the length of the slot in the guide rod for controlling the predetermined adjustment range, a pin extending there through the slot in the guide rod and the slot in the toothed segment to synchronize movement between the toothed segment and the guide rod when the adjusting device is locked by the quick unlocking device.

16. The vehicle seat as set forth in claim 12 further comprising a locking mechanism for locking the seat part in the second seat position, wherein pivoting of the backrest part from the folded over position in the second seat position to the upright position unlocks the locking mechanism to move the seat to the first seat position.

17. The vehicle seat as set forth in claim 1 wherein the adjusting device returns to a locked position after the seat part returns to the first seat position from the second seat position.

18. An adjustable seat for a vehicle comprising:
a seat part having a first seat position and a second seat position relative to a floor of the vehicle;
a backrest pivotally connected to the seat part;
an adjusting device for moving the seat part between the first seat position and the second seat position;
a locking device for fixing the seat part in the second seat position; and
a quick unlocking device operatively connected to the backrest part for unlocking the adjusting device, wherein pivoting of the backrest part from the upright position to the folded over position while in the first seat position actuates the quick unlocking device to unlock the adjusting device and move the seat to the second seat position and pivoting the backrest part from the folded over position to the upright position in the second seat position unlocks the locking device and the adjusting device to move the seat to the first seat position and the adjusting device returns to a locked position after the seat part returns to the first seat position.

19. The vehicle seat as set forth in claim 18 wherein the quick unlocking device includes:
a control member connected to the backrest part that is actuated by moving the backrest part between the upright position and the folded over position; and
an unlocking member having one end pivotally attached to the seat at a fourth pivot point, wherein the unlocking member engages the adjusting device in a locked position, and actuation of the control member pivots the unlocking member about the fourth pivot point to disengage the unlocking member from the adjusting device and unlock the adjusting device.

20. The vehicle seat as set forth in claim 18 wherein the adjusting device includes:
a guide rod having one end attached to the seat part, wherein the guide rod includes an elongated slot having a predetermined length for controlling adjustment of the seat part within a predetermined adjustment range for the first seat position;
a toothed segment adjacent the guide rod, wherein the toothed segment includes an elongated slot having a predetermined length that is less than the length of the slot in the guide rod for controlling the predetermined adjustment range, a pin extending there through the slot in the guide rod and the slot in the toothed segment to synchronize movement between the toothed segment and the guide rod when the adjusting device is locked by the quick unlocking device.
